(19) United States
(12) Patent Application Publication
(10) Pub. No.: US 2006/0216228 A1
(43) Pub. Date: Sep. 28, 2006

(54) Hydrogen generation

(76) Inventors: Richard R. Woods, Irvine, CA (US); Kandaswamy Duraiswamy, El Sobrante, CA (US)

Correspondence Address: Pauley Peterson & Erickson, Suite 365, 2800 West Higgins Road, Hoffman Estates, IL, 60195, US

(21) Appl. No.: 11/438,166

(22) Filed: May 22, 2006

Related U.S. Application Data
(63) Continuation of application No. 10/137,641, filed on May 2, 2002.
(60) Provisional application No. 60/288,016, filed on May 2, 2001.

(51) Int. Cl. C01B 3/26

(52) U.S. Cl. 423/652

(57) ABSTRACT

A hydrogen production apparatus for generating hydrogen comprises a first input for mixing a stream of liquid water with a stream of feed gas to produce a feed gas-water mixture stream and a heating mechanism for heating the feed gas-water mixture stream to a temperature sufficient to evaporate the water in the feed gas-water mixture stream to steam to produce a humidified feed-gas stream. A second input is provided for mixing the humidified feed-gas stream with a hydrocarbon fuel to produce a reformer reactant mixture of fuel, oxidant, and steam. A steam-methane reforming component reacts the hydrocarbon fuel and the steam in the reformer reactant mixture in a steam-methane reforming reaction to reform the hydrocarbon fuel in the reformer reactant mixture and produce a hydrogen enriched reformer product gas.

### CROSS REFERENCE TO RELATED APPLICATIONS

This application is a continuation and claims the benefit of U.S. patent application Ser. No. 10/137, 641, filed on 2 May 2002, and claims priority from U.S. Provisional Patent Application No. 60/288,016, filed on 2 May 2001. The co-pending parent application is hereby incorporated by reference herein in its entirety and is made a part hereof, including but not limited to those portions which specifically appear hereinafter.

### FIELD OF THE INVENTION

This invention relates to systems for generating hydrogen-gas for use in industrial and fuel cell applications.

### BACKGROUND OF THE INVENTION

Hydrogen gas is used in many industrial applications such as the hydrogenation of oils to make hydrogenated fats or the hydrogenation of phenol to cyclohexanol or the hydrogenation of nitrogen to ammonia or the hydrogenation of carbon-monoxide to methanol. In most cases, hydrogen is produced by the electrolysis of water. The hydrogen produced by such a method is then stored in tanks under high pressure. These tanks are shipped by rail or road transportation to the end user.

Since hydrogen is a highly flammable gas, its storage and transportation creates a public hazard. Therefore, more and more end-users are opting to produce hydrogen in-situ using alternate production methods such as the under-oxidation of readily available hydrocarbons such as methane, propane, etc. Another method of producing hydrocarbon in-situ is catalytic partial oxidation of hydrocarbons such as methane, propane, etc. Yet another method of producing hydrogen, which is well known, is the steam-methane reforming process wherein a light hydrocarbon such as methane is converted to hydrogen and carbon-monoxide.

A commercially available system for generating hydrogen at the end-user's site is marketed as the UOB™ system by Phoenix Gas Systems of Long Beach, Calif. A flow diagram of the UOB™ system is shown in FIG. 1. A detailed description of the under-oxidized burner is given in, for example, U.S. Pat. Nos. 5,207,185 and 5,728,183. In such systems, a suitable hydrocarbon fuel such as methane is mixed with a sub-stochiometric volume of oxygen and introduced to a reaction chamber wherein the partial oxidation of the methane takes place producing an intermediate product gas-stream, which is rich in hydrogen and carbon-monoxide. The intermediate product gas-stream is then quenched with demineralized water. The intermediate product gas and water mixture is then introduced into a shift reactor wherein the carbon-monoxide in the product gas-stream reacts with the water in the presence of a suitable catalyst to produce a final product gas-stream which consists mostly of hydrogen, carbon-dioxide, and nitrogen. Further purification of the final product gas-stream by condensation of the excess water-vapor and by pressure swing adsorption of the hydrogen provides a purified product gas-stream which contains more than 99% hydrogen.

The commercially available system described above operates at a high temperature and pressure. Further the under-oxidation process is quite parasitic in the consumption of the hydrocarbon fuel because a large quantity of hydrocarbon fuel must be used to raise the hydrocarbon-air mixture to a high temperature for the partial oxidation of the hydrocarbon to take place. The parasitic consumption of hydrocarbon fuel adds substantially to the cost of operation of the hydrogen generation plant. Further, the high operating temperature within the reactor necessitates the use of expensive materials of construction such as high temperature metal alloys and special refractories. These materials add substantially to the capital cost of the reactor.

The partial oxidation process has the disadvantage is that the hydrogen yield is lower than that of other hydrogen generation processes such as SMR and ATR processes. Approximately 1.5 moles per mole of methane are produced in the UOB™ partial oxidation process. It is possible to produce approximately 70 to 100 percent more hydrogen from a catalytic reforming system such as an SMR system or an ATR system.

However, one disadvantage of current catalytic reforming systems is that steam is required to be added to the process for the shift reaction to occur. This disadvantage is particularly significant in large capacity systems wherein a large quantity of steam is required for the shift reaction. In such cases, a fuel-fired boiler is generally used to provide the steam. However, the operation of large boilers is regulated by government agencies, which may mandate that the operation of steam boilers with capacities greater than a pre-set amount be supervised by a licensed operator. The use of an licensed boiler operator adds greatly to the cost of operation of partial oxidation systems and makes them relatively uneconomical to use compared to systems which do not need licensed operators. There is therefore a need for an improved hydrogen generation system, which operates at a lower temperature, consumes less parasitic fuel, does not require boiler generated steam, and can be operated without the use of skilled personnel.

### SUMMARY OF THE INVENTION

According to one aspect of the invention, there is provided a hydrogen production apparatus for generating hydrogen, the hydrogen production apparatus comprising: a first means for mixing a stream of liquid water with a stream of feed gas to produce a feed gas-water mixture stream; means for heating the feed gas-water mixture stream to a temperature sufficient to evaporate the water in the feed gas-water mixture stream to steam to produce a humidified feed-gas stream; and steam-methane reforming means for reacting the hydrocarbon fuel and the steam in the reformer reactant mixture in a steam-methane reforming reaction to reform the hydrocarbon fuel in the reformer reactant mixture and produce a hydrogen enriched reformer product gas. There may be a second means for mixing the humidified feed-gas stream with a hydrocarbon fuel to produce a reformer reactant mixture of fuel, oxidant, and steam.

According to another aspect of the invention, there is provided a hydrogen production apparatus for generating hydrogen comprising: a first means for mixing a stream of liquid water with a stream of oxidant to produce an oxidant-water mixture stream; means for heating the oxidant-water mixture stream to a temperature sufficient to evaporate the liquid water in the oxidant-water mixture stream to steam to produce a humidified oxidant stream; a second means for mixing the steam-oxidant mixture stream with a hydrocarbon fuel to produce a reformer reactant mixture of fuel, oxidant, and steam; and reforming means for allowing the oxidant to partially oxidize the hydrocarbon fuel in the reformer reactant mixture and allowing the steam to reform the hydrocarbon fuel in the reformer reactant mixture to produce a hydrogen enriched reformer product gas.

In yet another aspect, the invention is for a hydrogen production apparatus for generating hydrogen comprising: a first means for mixing a stream of liquid water with a hydrocarbon fuel stream to produce a fuel-water mixture stream; means for heating the fuel-water mixture stream to a temperature sufficient to evaporate the water into steam to produce a humidified fuel stream; a second means for mixing the humidified fuel stream with an oxidant to produce a reformer reactant mixture of fuel, oxidant, and steam; and reforming means for allowing the oxidant to partially oxidize the hydrocarbon fuel in the reformer reactant mixture and allowing the steam to reform the hydrocarbon fuel in the reformer reactant mixture to produce a hydrogen enriched reformer product gas.

According to another aspect of the invention, there is provided a hydrogen production apparatus for generating hydrogen comprising: a first means for mixing a first stream of liquid water with a stream of oxidant to produce an oxidant-water mixture stream; means for heating the oxidant-water mixture stream to a temperature sufficient to evaporate the liquid water into steam to produce a humidified oxidant stream; a second means for mixing a second stream of liquid water with a hydrocarbon fuel stream to produce a fuel-liquid water mixture stream; means for heating the fuel-liquid water stream to a temperature sufficient to evaporate the liquid water into steam to produce a humidified fuel stream; a third means for mixing the humidified fuel stream with the humidified oxidant stream to produce a reformer reactant mixture of fuel, oxidant, and steam; and reforming means for allowing the oxidant to partially oxidize the hydrocarbon fuel in the reformer reactant mixture and allowing the steam to reform the hydrocarbon fuel in the reformer reactant mixture to produce a hydrogen enriched reformer product gas.

### BRIEF DESCRIPTION OF THE DRAWINGS

FIG. 1 is a flow-diagram of the UOB™ process according to the prior art;

FIG. 2 is a flow-diagram of an improved hydrogen generation system according to the present invention which uses an ATR (autothermal reformer) and which is used with a pressure swing adsorption system to generate a relatively pure hydrogen gas for industrial purposes;

FIG. 3 is a flow-diagram of another embodiment of the improved hydrogen generation system according to the present invention which uses an ATR and which is used with a fuel-cell to generate electricity;

FIG. 4 is a flow-diagram of an improved hydrogen generation system according to the present invention which does not include a shift reactor and which is used with a pressure swing adsorption system to generate a relatively pure hydrogen gas for industrial purposes; and

FIG. 5 is a flow-diagram of another embodiment of the improved hydrogen generation system according to the present invention which uses a SMR reactor and which is used with a fuel-cell to generate electricity.

### DETAILED DESCRIPTION OF THE INVENTION

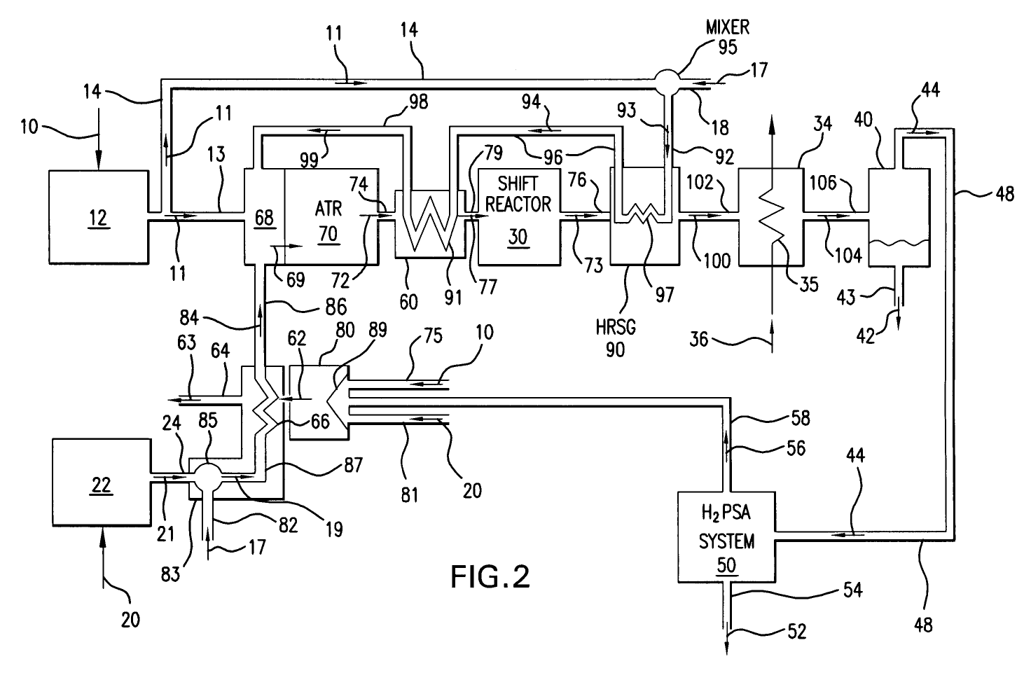

Referring now to FIG. 2, which is a representation of the improved hydrogen generation process according to the present invention. The improved hydrogen generation system consists of a Fuel Conditioning System (FPS) 12, an Oxidant Supply System (OSS) 22, a PSA tail-gas combuster 80, a Humidification System (HS) 83, an Auto-Thermal Reformer (ATR) 70, a Shift Reactor 30, a Heat Recovery Steam Generator (HRSG) 90, an intercooler 34, a condensate blow-down tank (CBT) 40, and a Pressure Swing Adbsorber (PSA) 50.

Referring now to the fuel conditioning system 12, a fuel 10 such as methane, propane, butane or other such suitable light hydrocarbon is introduced into fuel processing system 12. Fuel-processing system 12 may include components (not shown) such as a gas-filter, a compressor, a de-sulfurization system, or any devices that may be required to condition fuel 10 for use in the subsequent processing stages. If fuel 10 is a liquid hydrocarbon fuel such as kerosene, gasoline, methanol, etc, then FCS 12 could also include a means (not shown) to convert the liquid fuel to a gaseous state. Such means could include process equipment such as an evaporator or a spray mist or a sparger or a fired vaporizer. The conditioned fuel designated as 11 in FIG. 2 is then transported through a pipe 13 to the Auto-Thermal Reformer (ATR) inlet zone 68 where it is mixed with other gases as described below.

Referring now to Oxidant Supply System (OSS) 22, an oxygen containing gas-stream 20 such as air is introduced into OSS 22. OSS 22 may include components (not shown) such as an air-filter, a compressor, or any other devices that may be required to condition oxygen containing gas-stream 20 for use in the subsequent processing stages. The conditioned oxygen containing gas-stream designated as 21 in FIG. 2 is then transported through a pipe 24 to HS 83 for humidification as will be described below. HS 83 comprises a means 85 for adding liquid water 17 to the conditioned air stream 21 to form a mixture 19 of liquid water and air and a means 66 for heating the mixture 19 to evaporate the liquid water in mixture 19.

In HS 83, a water stream 17 is introduced through pipe 82 for humidification of the conditioned oxygen containing gas-stream 21. Water stream 17 is contacted with gas-stream 21 in a mixing device 85 located within HS 83. Mixing device 85 can be any device which enables a liquid stream and a gas stream to make intimate contact to produce a gas stream that is saturated with the liquid. For example mixing device 85 could be a spray nozzle, a sparger, a humidification tower, etc. The humidified conditioned oxidant stream is shown as 19 in FIG. 2 and is conveyed from HS 83 to PSA tail-gas combuster 80 through pipe 87.

In PSA tail-gas combuster 80, the humidified conditioned oxygen containing gas-stream is passed through a heat transfer passage 66 wherein it is indirectly heated to about 75 to 300 degrees C. by a hot flue gas stream 62. A further description of the process of generating hot flue gas stream 62 and of the operation of the PSA tail-gas combuster is provided subsequent sections of this description.

The heated humidified oxygen containing stream, now designated as 84 in FIG. 2, is then transported through pipe 86 which connects to reactor inlet zone 68. In reactor inlet zone 68, the conditioned fuel 11 is mixed with the hot, humidified oxygen containing stream 84. A fuel and steam mixture 99, which is transported to reactor inlet zone 68 through steam pipe 98, is also added to reactor inlet zone 68. The steam used in natural gas-steam mixture 99 may be generated in a separate boiler (not shown) or preferably may be generated in HRSG 90 as will be described in subsequent sections. The mixture of conditioned fuel 11, hot, humidified oxygen containing gas stream 84, and fuel-steam mixture 99 forms ATR reactant mixture 69, which is introduced into the ATR 70 for conversion to hydrogen, carbon-monoxide, and carbon-dioxide as will be described further below.

As defined herein, an Autothermal Reformer (ATR) is a device for the conversion of a mixture of hydrocarbon, steam, and oxygen to a hydrogen-rich gas, which may or may not also contain carbon-monoxide as a byproduct.

An ATR may or may not utilize catalysts for carrying out the above conversion. However, the use of catalysts in the ATR reduces the average operating temperature of the conversion reaction and is therefore preferred in commercial ATR applications.

In an ATR, the primary reactions, which facilitate the conversion of the hydrocarbon to a hydrogen-rich gas, are a partial oxidation reaction and a steam methane reforming (SMR) reaction. If catalysts are used for the conversion, the partial oxidation reaction is generally referred to as a Catalytic Partial Oxidation (CPO) reaction. The partial oxidation reaction for the conversion of methane is as shown below:
CH4+0.5(O2)→CO+2(H2).

The CPO reaction is exothermic and therefore has the advantage of very fast response to a change in the hydrogen demand from the fuel-cell. The partial oxidation reaction can be catalytically or non-catalytically driven. The catalytically driven partial oxidation reaction generally uses a monolithic catalyst containing precious metals such as Platinum, Palladium, and Rhodium. The catalytically driven partial oxidation reaction occurs at around 600 to 900 degrees C. The non-catalytically driven Partial Oxidation reaction generally occurs around 1,000 to 1,500 degrees C. Thus more of the fuel is parasitically consumed to achieve the higher temperature of the non-catalytic CPO reaction than is consumed in the catalytic CPO reaction.

The second reaction that takes place in an ATR is the SMR reaction, which is described by the following chemical reaction:
CH4+H2O→CO+3H2

The above reaction is highly endothermic and may take place without a catalyst. However, a catalyst such as SMR-5 supplied by Engelhard Corporation can also be used to enable the reaction to take place at a lower temperature with a lower input of heat energy. Yet other nickel containing catalyst such as those supplied by United Catalysts or Haldor Topsoe could also be used to enable the reaction to take place at a lower temperature with a lower input of heat energy. The use of such catalysts generally enable the SMR reaction to take place at around 600 to 900 degrees C. The endothermic nature of the reaction increases the response time for the SMR reaction to provide higher quantity of hydrogen in response to fuel-cell hydrogen-load demand. Heat energy for the endothermic SMR reaction can be provided either through external heating means such as heat transfer coils embedded within the catalyst mass or internally generated by the partial oxidation of the hydrocarbon in the CPO reaction described previously. Therefore in an ATR, the exothermic reaction from the CPO reaction is balanced by the endothermic heat of the SMR reaction.

The combination of the CPO and the SMR reactions in an ATR provides a gas-stream with a higher concentration of hydrogen than that produced by the CPO reaction alone. Further, this combination also provides a faster response to fuel-cell hydrogen load demands than is possible with a SMR reaction alone.

While the ATR consists predominantly of the CPO and SMR reactions, some Water Gas Shift (WGS) reactions may also occur within the ATR as described by the following chemical equation:
CO+H2O→CO2+H2

The WGS reaction reacts some of the CO generated during the CPO reaction with some of the steam to produce additional hydrogen.

Separate catalysts can be used for the CPO reaction and the SMR reactions. Thus a Platinum-Palladium catalyst could be used to effect the CPO reaction while a Platinum-Rhodium catalyst could be used for the SMR reaction. Alternatively, an advanced catalyst that contains the Platinum-Palladium as well as the Platinum-Rhodium combinations to carry out the CPO and the SMR reactions could also be used.

The ATR product gases are designated as 72 in FIG. 2 and approximately consist of 30 to 40% hydrogen, 5 to 7% carbon-monoxide, 7 to 14% carbon-dioxide, 0.1 to 3% unreacted hydrocarbon or methane, 10 to 35% excess steam, and 20 to 30% nitrogen from air (if air is used as the oxygen-containing stream 20). The ATR gases or reformed products 72 are transported through a pipe 74 to a superheater 60 wherein the reformed products 72 are cooled by heat transfer to a humidified fuel mixture 94 which is flowed in a heat transfer passage 91 which is located within superheater 60 for heat transfer communication with reformed products 72. A description of the method of generating and conveying humidified fuel mixture 94 to superheater 60 is described below. In superheater 60, the hot reformed product gases are cooled to an intermediate temperature, generally about 300 to 400 degrees C. (or 600 to 700 degrees F.), which is suitable for operation of shift reactor 30 which is described below. The humidified fuel mixture 94 is flowed through pipe 96 from HRSG 90 to superheater heat transfer passage 91 in superheater 60. The superheated humidified fuel mixture is shown in FIG. 2 as 99 and is flowed out of superheater heat transfer passage 91 through pipe 98 which transports it to ATR inlet zone 68 for mixing with conditioned fuel 11 and humidified air 84 as previously described.

The cooled reformed product gases are shown in FIG. 2 as 77 and are removed from superheater 60 by pipe 79 which transports them to shift reactor 30 wherein the carbon-monoxide in the reformed product gases 72 is reacted with the excess steam to form carbon-dioxide and hydrogen according to the shift reaction described above. Thus shift reactor 30 further increases the yield of the hydrogen that is produced by the system by utilizing the undesired carbon-monoxide to reduce the excess steam to hydrogen. Another advantage of the shift reactor is that it improves the operation of PEM fuel-cells by reducing the concentration of the Carbon-Monoxide in ATR product gas stream 72 since the electrodes of PEM fuel cells are adversely affected by high concentrations of carbon-monoxide in the reformed gas stream that is used as a source of hydrogen.

As defined herein, a Shift Reactor is a device wherein a gas-stream containing carbon-monoxide and steam is converted to a product gas-stream containing carbon-dioxide and hydrogen through the Water Gas Shift reaction described above. The conversion is generally effected by passing the carbon-monoxide and steam mixture over an iron-oxide catalyst. However other catalysts could also be used to effect the chemical reaction described above.

A shift reactor can be a single stage or a multiple stage device. Generally, the shift reaction is carried out in two stages. The first stage is generally referred to as a High Temperature Shift (HTS) reaction wherein the mixture of carbon-monoxide and steam is passed over a catalyst which is maintained at 300 to 400 degrees C. At such high temperatures, the reaction rate for the WGS reaction is relatively high but the amounts of carbon-monoxide and water that are converted to carbon-dioxide and hydrogen are relatively low. This is because the WGS reaction is slightly exothermic; therefore, heat is produced which tends to reduce the conversion of the steam to hydrogen. To increase the conversion in the WGS reaction, the partially converted products from the High Temperature Shift reaction are generally cooled to about 170 to 200 degrees C. in an intercooler (not shown) and introduced into a second stage, which is conventionally referred to as a Low Temperature Shift (LTS) Reactor. In the LTS reactor, the partially converted products of reaction from the HTS reactor are passed over a copper-zinc oxide catalyst, which is maintained at about 170 to 200 degrees C. Essentially equilibrium conversion of the carbon-monoxide takes place in the LTS catalyst to produce a hot gas-stream (designated as 73 in FIG. 2) which contains approximately 30-70 percent hydrogen, 0.1 to 10 percent carbon-monoxide, 10-20 percent carbon-dioxide, 15-30 percent water, traces of hydrocarbon fuel, and 0-35 percent nitrogen (if air is used as the source of oxygen containing gas-stream 20).

For purposes of simplicity, the shift reactor is represented by a single block in FIG. 2. However, the depicted shift reactor block could contain multiple stages and intermediate product coolers which are not shown in FIG. 2.

The hot shift reactor product gas-stream 73 is transported by pipe 76 from shift reactor 30 to HRSG 90. The hot shift reactor product gas stream 73 is at around 600 degrees and is cooled further before being directed to the PSA for separation of the hydrogen. The cooling is effected in HRSG 90 and a intercooler 34. A water saturated fuel gas stream, shown in FIG. 2 as 93, is also introduced to HRSG 90 through pipe 92. Water saturated fuel gas stream 93 is created by passing a slip-stream of conditioned fuel 11 through pipe 14 to a mixing device 95 which is also connected to a pipe 18 wherein water 17 is flowed. Mixing device 95 intimately contacts fuel 11 with water 17 to produce a water saturated fuel gas stream 93. As described previously for mixing device 85, mixing device 95 can be any mixing element such as a spray nozzle, sparger, humidification tower, etc. The water saturated fuel gas stream 93 is flowed to HRSG 90 through pipe 92. In HRSG 90, hot shift reactor product gas-stream 73 in passed on the heating side of a heat-transfer passage 97 while water saturated fuel gas mixture 93 is passed on the cooling side of the same heat-transfer passage 97. Heat is transferred from the hot gas-stream 73 to the relatively colder water saturated fuel gas mixture 93. The absorption of heat causes the water 17 in water saturated fuel gas mixture 93 to evaporate and get converted into steam. Thus heat-transfer passage 97 converts water-saturated fuel gas mixture 93 into humidified fuel gas stream 94, which, as described previously, is transported to heat transfer passage 91 of superheater 60 through pipe 96. Hot gas-stream 73, which is cooled by transferring its heat to water saturated fuel gas mixture 93 in the HRSG, is designated as 100 in FIG. 2 and is transported out of HRSG 90 through pipe 102 which conducts it to intercooler 34.

Intercooler 34 can be any heat-exchange device whose function is to further cool shift reactor product gas 100 to a temperature, which is below the dew-point of gas-stream 100 so that the excess steam in gas-stream 100 can be condensed out in a subsequent condensation step which will be described below. For example, intercooler 34 could be a shell- and tube heat exchanger wherein cooling water 36 is passed over a heat-transfer surface of a heat-transfer passage 35 to cool hot gas stream 100 which is flowed over the other heat transfer surface of the heat transfer passage 35. Alternatively, intercooler 34 could be an air-cooled heat exchanger wherein heat-transfer passage 35 is a set of finned tubes through which hot shift reactor product gas stream 100 is flowed while cold ambient air is flowed over the finned surfaces of the finned tubes to effect the cooling of hot gas stream 100. Alternatively, intercooler 34 could be a shell and tube heat exchanger wherein a cold process stream is used to cool hot shift reactor product gas stream 100 while being preheated to conserve energy. Any of these devices could be used as intercooler 34 to convert single phase gas-stream 100 to a two-phase gas-stream which is designated as 104 in FIG. 2. Two-phase gas-stream 104 is transported through pipe 106 from intercooler 34 to condensate blow-down tank 40. In condensate blow-down tank 40, two-phase gas stream 104 is cooled to a temperature less than its dew-point through adiabatic expansion. The cooling of two-phase gas stream 104 below its dew-point causes the excess steam in two-phase gas stream 104 to condense out.

Condensate knock-out tank 40 can be any expanded volume wherein two-phase gas stream 104 can be adiabatically expanded. Further, the configuration of condensate knock-out tank 40 can be seleced so that the velocity of two-phase gas-stream 104 is reduced so that the water, which was condensed out of the gas-phase in the two-phase gas-stream 104, coalesces and gravitationally or centrifugally separates out of two-phase gas stream 104. However, condensate blow down tank 40 could also include other means of removing drops of liquid from a gas stream. Such means could include devices such as as de-misters, and packed towers. The condensate 42 is removed from condensate blow-down tank 40 by means of condensate removal pipe 43. Liquid level maintenance and control means (not shown) can be used within condensate blow-down tank 40 to maintain a constant level of liquid within the tank to prevent any inadvertent loss of product gas from the system through condensate removal pipe 42. Gas-stream 104, after removal of the excess water, is designated as 44 in FIG. 2. The de-watered gas-stream 44 is transported by pipe 48 from CBT 40 to PSA 50 wherein a concentrated hydrogen gas-stream is produced as described further below.

PSA 50 is any device wherein the Pressure Swing Adsorption principle is used to adsorb and desorb the hydrogen in gas stream 44. Such pressure swing adsorption cycles are well known and consist of an adsorption cycle wherein the hydrogen in gas-stream 44 is adsorbed under high pressure on a suitable adsorption material while the other components of the gas-stream 44 are allowed to pass through. The second phase of the PSA cycle is a desorption cycle wherein the pressure within the PSA system is reduced to enable the adsorbed hydrogen to desorb from the adsorbent. Typically two beds containing the adsorption material are used so that one bed can operate in adsorption mode while the second bed is operated in a desorption mode. After a period of time, the bed that was previously operated in an adsorption mode is then switched to a desorption mode and the bed that was previously operated in a desorption mode is then switched to an adsorption mode. Such an arrangement enables the process gas which needs purification to be continuously treated without any interruption in flow. An example of a commercially available PSA system that can be used for producing a highly concentrated hydrogen gas stream from de-humidified gas stream 44 is the PSA system sold by Questor Corporation of Vancouver, Canada.

While a pressure swing adsorption system is described herein, other types of concentrating devices could also be used as hydrogen concentrators. For example, a temperature swing adsorption device could also be used to produce a concentrated stream of hydrogen from de-humidified gas-stream 44. Other non-adsorption based hydrogen concentration devices could also be used. For example, the hydrogen concentration device could be a molecular sieve or a hydrogen separation membrane. Such devices are commercially available from various manufacturers.

As shown in FIG. 2, during the adsorption cycle, PSA 50 converts gas-stream 44, which contains approximately 30 to 75 percent hydrogen to a concentrated gas-stream 52, which contains approximately 98 to 99.9999 percent hydrogen. Hydrogen gas-stream 52 is transported from PSA 50 through pipe 54, which conducts it to the end-user's process (not shown) or a tank filling station (also not shown). Also as shown in FIG. 2, during the desorption cycle, PSA 50 converts gas-stream 44, which contains approximately 30 to 70 percent hydrogen to a diluted gas-stream 56 which contains approximately 5 to 15 percent hydrogen. Further, the diluted gas-stream also contains approximately 15 to 30 percent of carbon oxides as well as other components such as nitrogen, water-vapor, and unconverted methane. The diluted gas-stream 56 is also known as a PSA tail-gas stream or a PSA waste-gas stream. PSA waste gas-stream 56 is transported from PSA 50 through pipe 58, which conducts it to the previously described PSA tail-gas oxidizer combuster 80.

In PSA tail-gas oxidizer 80, waste gas-stream 56 is passed through a fuel-burner, shown as 89. Fuel burner 89 can be any suitable combustible gas burner such as a duct burner or a pre-mixed gas burner such as those available from U.S. manufacturers such as Maxon, North American, Coen, Eclipse etc. Fuel burner 89 could also be a metal-fiber burner such as that available from U.S. manufacturers such as, for example, Acotech. Oxygen for combustion of PSA tail gas stream 56 is provided to burner 89 by pipe 81 which feeds an oxygen containing gas stream 20 to burner 89. Thus waste gas 56 is mixed with oxygen containing gas stream 20 before combustion of the combustibles in waste gas 56 takes place in burner 89. However, it is not necessary that the two streams be mixed. If a duct burner is used, only waste gas stream 56 can be passed through burner 89 while the oxygen containing gas stream 20 is passed over the burner to provide the oxygen for combustion of the combustibles in waste gas stream 56. Yet further a source of natural gas 10 is connected to burner 89 through pipe 75. This natural gas 10 is combusted during the start-up of the equipment and is used to bring the PSA combuster up to temperature prior to receiving PSA tail-gas 56. Thus complete combustion of PSA tail-gas 56 is ensured. Further, the combustion of natural gas 10 in burner 89 provides heat during start-up of the equipment to mixture 19 of oxygen-containing gas and water that is flowed through heat transfer passage 66 as previously described and indirectly assists in heating the ATR at start-up.

During the passage of waste-gas stream 56 through the fuel-burner 89, the hydrogen as well as the other hydrocarbons in waste stream 56 combine with the oxygen in oxygen containing gas stream 20 to produce hot gaseous products of combustion (designated as 62 in FIG. 2) which consist mostly of carbon-dioxide, water, and nitrogen. The hot products of combustion 62 are passed over the heat transfer surfaces of a heat-transfer passage which is located within PSA combuster 80. The heat-transfer passage is shown as 66 in FIG. 2. The previously described mixture 19 of oxygen containing gas-stream 21 and water 17 is passed over the other heat transfer surface of heat transfer passage 66 of PSA combuster 80. Thus, the hot products of combustion 62 give up part of its heat to the relative cooler mixture 17 of oxygen containing gas-stream 21 and water 17. The cooled products of combustion are shown in FIG. 2 as 63 and are removed from HS 80 by pipe 64. Cooled products of combustion 63 are conducted by pipe 64 to the atmosphere or to subsequent processing stages.

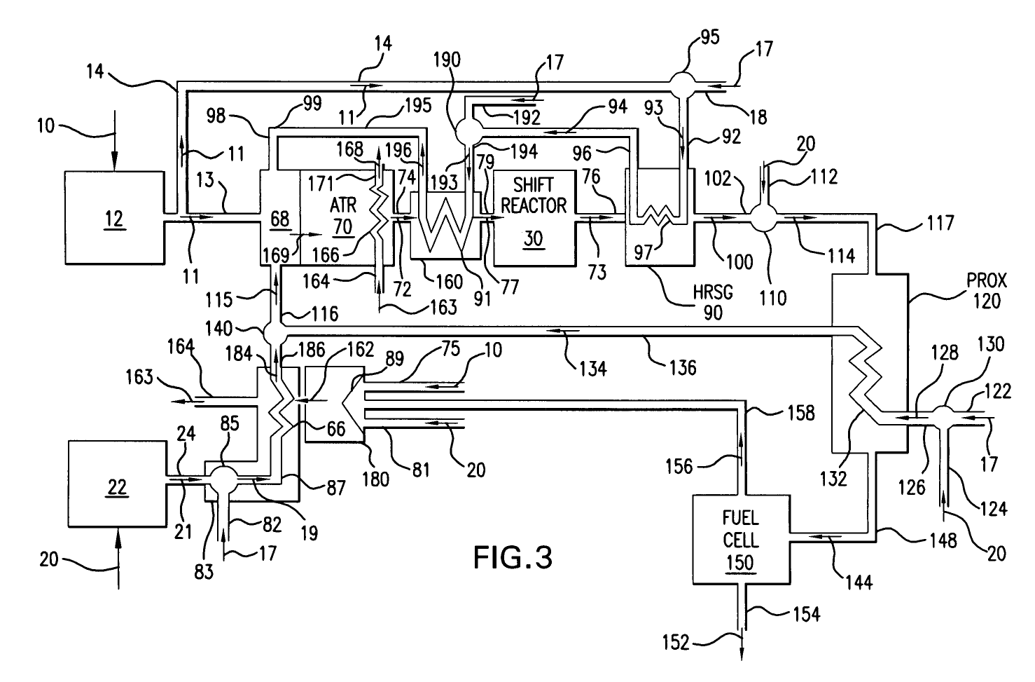

Yet another embodiment of an improved hydrogen generation system that can be used with a fuel-cell system is shown in FIG. 3. The improved hydrogen generation system of FIG. 3 shares most of the components of the hydrogen generation system that was previously described for FIG. 2. Hence similar components of FIGS. 2 and 3 are shown similarly numbered.

Fuel 10 is conditioned by passing through fuel conditioning system 12 before being passed into the reactor inlet zone 68 through pipe 13. A part of the conditioned fuel 11 is diverted to mixer 95 wherein it is mixed with water 17 to provide a water-saturated fuel stream 93, which is passed first through heat transfer passage 97 of HRSG 90 and then through heat transfer coil 91 of superheater 60. The water 17 in water-saturated fuel stream 93 is evaporated in heat transfer passages 97 and 91 and a superheated humidified fuel stream 99 is passed to reactor inlet zone 68 through pipe 98 or 195. As will be described below, a humidified air stream 115 is also passed into ATR inlet zone 68 and is mixed with conditioned fuel 11, and super-humidified fuel stream 196 to produce an ATR reactant mixture 169 which includes fuel, steam, and oxygen.

The amount of water 17 that is introduced into mixers 85 and 95 is varied depending on the mode of operation of ATR 70. During the start-up of the system, essentially all of the water that is required for ATR 70 is introduced into mixer 85 and no water is introduced into mixer 95. After the ATR 70 has reached a normal operating mode, the water that is introduced to mixer 85 is reduced to about 66 percent of the total water requirements for ATR 70. The balance 33 percent of the water that is required for ATR 70 is now introduced through mixer 95. Thus the total water requirements for ATR 70 are now introduced in 2:1 proportions in mixers 85 and 95 respectively.

ATR reactant mixture 169 is passed into ATR 70 wherein predominantly CPO and SMR reactions take place to provide a hydrogen rich gas stream 72. ATR 70 is equipped with a heating coil 166 which is embedded within the catalyst mass of the ATR. As will be described below, hot products of combustion 163 from Anode Gas Oxidizer (AGO) 180 are passed over the heat transfer surfaces of heating coil 166 to provide heat for the endothermic SMR reaction occurring within the catalyst mass of ATR 70. Thus a relatively higher yield of hydrogen is obtained from ATR 70 compared to ATR 70 of FIG. 2. Hydrogen rich gas stream 72 is next conveyed to shift reactor 30 by pipe 74.

The hydrogen rich gas stream 72 is then passed through a secondary HRSG 160 wherein the hot hydrogen rich stream 72 is partially cooled by passing it on the cooling side of a heat transfer passage 91 which contains a liquid water-humidified fuel mixture 193 on its heat-receiving side. The method of generating and transporting liquid water-humidified fuel mixture 193 to heat transfer passage 91 in secondary HRSG 160 is described below. The partially cooled hot hydrogen rich stream exiting secondary HRSG 60 is shown in FIG. 3 as 77. Partially cooled hot hydrogen rich stream 77 is conveyed from secondary HRSG 160 to Shift Reactor 30 by pipe 79. In heat transfer passage 91, the liquid water in liquid water-humidified fuel mixture 193 evaporates. Thus a super-humidified fuel stream 196 is produced in heat transfer passage 91. Super-humidified fuel stream 196 is removed from heat transfer passage 91 by pipe 195 which conveys it from secondary HRSG 60 to ATR inlet zone 68. As previously described, in ATR inlet zone 68, super-humidified fuel stream 196 is mixed with conditioned fuel 11 and humidified air stream 115 to create ATR reactant mixture 169.

Liquid water-humidified fuel stream 193 is created by mixing liquid water stream 17 with HRSG 90 generated humidified fuel stream 94 in mixer 190. The production of humidified fuel stream 94 in HRSG 90 is described below. Humidified fuel stream 94 is conveyed from HRSG 90 to mixer 190 through pipe 96 while liquid water 17 is conveyed to mixer 190 through pipe 192. Mixer 190 can be any of the different kinds of mixers described previously. The mixture of liquid water and humidified fuel stream which is produced by mixer 190 is shown in FIG. 3 as 193 and is conveyed from mixer 190 to heat transfer passage 91 of secondary HRSG 60 by pipe 194.

The partially cooled hot hydrogen enriched gas 77 is conveyed by pipe 79 from secondary HRSG 160 to shift reactor 30. In shift reactor 30, the shift reactions described above take place to react the steam and carbon-monoxide in hydrogen rich gas stream 72 to exothermically produce more hydrogen. The hot hydrogen enriched gas stream 73 is then removed from shift reactor 30 through pipe 76, which conveys it to HRSG 90.

In HRSG 90, the hot hydrogen enriched gas stream 73 is passed over the heat transfer surface of heat transfer passage 97 to heat up the humidified fuel stream 93 that is flowed over the other side of the heat transfer surface of heat transfer passage 97. The hot hydrogen enriched gas stream is partially cooled by the relative cooler humidified fuel stream 93 in heat transfer passage 97. The partially cooled hydrogen enriched gas stream 100 is removed from HRSG 90 by pipe 102 and is conveyed to a gas mixer 110.

In gas mixer 110, the partially cooled hydrogen enriched gas stream 100 is mixed with an oxygen containing gas stream 20 that is introduced to mixer 110 through pipe 112. The mixture of hydrogen enriched gas 100 and oxygen containing gas 20 is shown as 114 in FIG. 3 and is conveyed from mixer 110 to Preferential Oxidation (PROX) reactor 120 by pipe 117.

As described herein, a PROX reactor is a reactor which contains catalyst which facilitates the oxidation of carbon-monoxide in preference to the oxidation of other oxidizable components in a gas-stream. Thus in PROX 120, the catalyst facilitates the reaction of carbon-monoxide with oxygen to produce carbon-dioxide while hindering the reaction of hydrogen with oxygen to water. The selectivity of the catalyst for one reaction versus another reaction is dependent on temperature. Thus at lower temperatures, the catalyst is more selective to the oxidation of carbon-monoxide according to the following reaction
CO+O2→CO2
and less selective to the oxidation of hydrogen according to the following reaction:
H2+O2→H2O.

Thus hydrogen loss due to oxidation is lower at reduced temperatures. In practice, operation of the PROX reactor at low temperatures is limited by the lower reaction rate that exists at low temperatures for exothermic reactions. Thus in practice, PROX reactors are operated in multiple stages with intercooling heat exchangers to remove heat generated in each exothermic reaction stage.

Inter-stage cooling of the PROX reactor 120 is carried out by means of coil 132. While a single continuous coil is shown in FIG. 3, coil 132 can be configured as multiple coils connected in series and located between adjacent reaction stages of PROX reactor 120. However, coil 132 can also be multiple coils connected in parallel and located between adjacent reaction stages of PROX reactor 120. Humidified air 128 is passed through coil 132 to effect the coil of the reaction gases in between reaction stages. Humidified air 128 is produced by contacting a water stream 17 with a gas stream 20 in a mixer 130. The water stream 17 is introduced to mixer 130 through a pipe 122 and the air stream 20 is introduced to mixer 130 through pipe 124. Any of the previously described mixing devices can be used as mixer 130. The humidified air 128 is passed from mixer 130 to coil 132 through pipe 126. The humidified air 128 is heated in coil 132.

The heated humidified air is shown in FIG. 3 as 134 and is passed to mixer 140 through pipe 136. A further description of mixer 140 and its operation in the system is given below.

As described previously with respect to the system of FIG. 2, the amount of water 17 that is introduced into mixers 85, 95 and 130 of the system of FIG. 3 is also varied depending on the mode of operation of ATR 10. During the start-up of the system, essentially all of the water that is required for ATR 10 is introduced into mixer 85 and no water is introduced into mixers 95 and 130. After the ATR has reached a normal operating mode, the water that is introduced to mixer 85 is reduced to about zero percent of the total water requirements for ATR 70. The balance 100 percent of the water that is required for ATR 70 is now introduced through mixers 95 and 130 in a 2:1 proportion. Thus the total water requirements for ATR 70 are now introduced in 2:1 proportions in mixers 95 and 130 respectively while no water is introduced in mixer 85.

The use of humidified air stream 134 in the cooling coil of PROX reactor 120 allows the PROX catalyst to operate at a lower temperature than PROX reactors of the prior art which utilize water as the coolant. The use of lower operating temperature for the PROX reactions provides greater selectivity of the PROX reaction with respect to carbon-monoxide versus hydrogen. While the above description details the use of a humidified gas stream 134 as a coolant in the PROX reactor, other gas mixtures could also be used. For example, gas stream 134 could be a humidified natural gas stream (mixture of natural gas and water-vapor).

The PROX product gas is a reformer gas that is low in carbon-monoxide which is generally in the range of 10-50 ppm. The PROX product gas produced by the PROX reactor 120 is shown as reformed gas 144 in FIG. 3 and is removed from PROX reactor 120 by pipe 148. Reformed gas 144 is passed by pipe 148 to the anode of Fuel Cell 150, which consumes the hydrogen in the reformed gas 144 to produce electricity 152 which is removed from Fuel Cell 150 by electrical conductors 154. The spent anode gas from fuel cell 150, shown as 156 in FIG. 3 contains between 15-50% hydrogen (dry volume basis) at a fuel-cell SR of 1.2 and is generally referred to as Anode Off Gas (AOG). AOG 156 is removed from FC 150 by pipe 158 which conveys it to the burner 89 of Anode Off Gas Oxidizer (AGO) 180.

An oxygen containing gas 20 is also introduced to burner 89 through pipe 81. Further, fuel 10 is also introduced to burner 89 through pipe 75. Fuel 10 can be used during start-up of the equipment when AOG 156 is not available. Oxygen containing gas stream 20 can also be the cathode off-gas, which contains approximately 15% oxygen, from the cathode side of FC 150.

The hydrogen and other combustibles in AGO 180 is combusted in burner 89 to produce a hot flue gas 162, which is passed over a heat-transfer surface of heat transfer passage 66 which is located within AGO 180. A humidified oxygen containing stream 19 is passed on the other side of the heat transfer surface of heat transfer passage 66 to cool the hot flue gas 162. The partially cooled hot flue gas is shown as 163 in FIG. 3 and is removed from AGO 180 by pipe 164 which is connected to previously described heat-transfer passage 166 in ATR 70. Additional heat is removed from partially cooled flue gas 163 in ATR 70 and is used to provide heat to maintain the endothermic SMR reaction in ATR 70. The further cooled oxidized AOG is shown in FIG. 3 as 168 and is removed from heat-transfer passage 166 by pipe 171.

As previously described, humidified oxygen containing gas stream 19 is passed over the heat transfer surface of heat-transfer passage 66 to cool flue gas 162 which was created by the combustion of the anode off gas 156 in burner 89 of AGO 180. The humidified oxygen containing gas stream 19 is generated by intimately contacting a conditioned oxygen containing gas stream 21 with a stream of water 17 in a gas mixer 85 in humidification system 83. The humidified oxygen containing gas stream 19 is passed to heat transfer passage 66 by connecting pipe 87. The heated humidified oxygen containing gas stream which exits heat transfer passage 66 is shown as 184 in FIG. 3 and is conveyed out of heat transfer passage 66 by pipe 186 to gas mixer 140. In gas mixer 140, the heated humidified oxygen containing gas stream 184 is mixed with heated humidified oxygen containing steam 134 which, as previously described, was heated in heat transfer gas passage 132 of PROX reactor 120. The mixture of heated humidified oxygen containing gas stream 184 and heated humidified oxygen containing stream 134 is shown as 115 in FIG. 3 and exits mixer 140 through pipe 116 which conveys it to ATR mixing zone 68 wherein, as previously described, it is mixed with conditioned fuel 11 and humidified fuel stream 196 to form the ATR reactant mixture 169. As previously described, ATR reactant mixture 169 is passed into ATR 70 for conversion to ATR product gas 72.

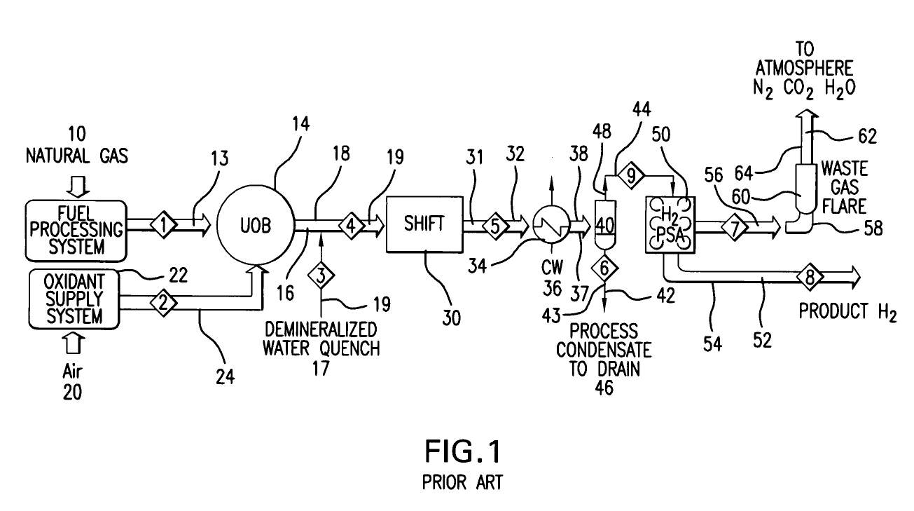

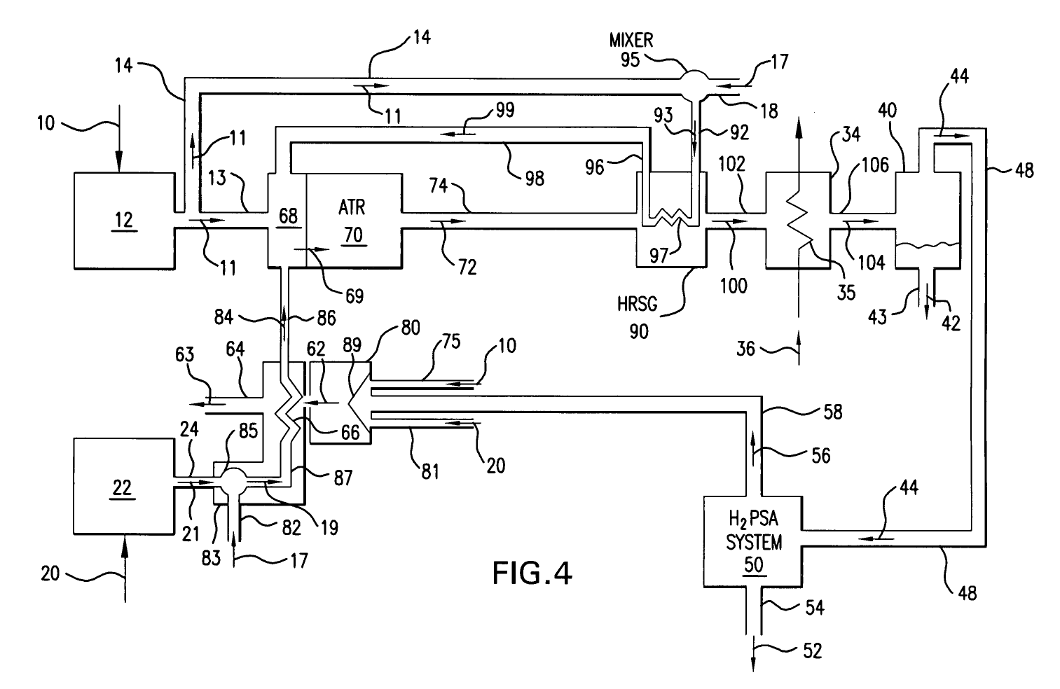

Yet other embodiments of an improved hydrogen generation system according to the present invention are also possible. For example, FIG. 4 shows a process flow representation of an improved hydrogen generation system, which eliminates the shift reactor 30 shown in FIG. 1. Such a system could be used in cases where recovery of carbon-monoxide gas is economically viable or where simplification of the process is desired. Hence, the carbon-monoxide gas that is generated in the ATR is not used for converting water to hydrogen in the shift reactor and is separated in tail gas 56 of PSA 50. PSA Tail gas 56 can then be processed in other separating devices (not shown) to recover the carbon-monoxide. Alternatively, as shown in FIG. 4, the carbon-monoxide in PSA tail-gas 56 can be burnt in burner 89 of PSA combuster 80 to provide additional heat energy input into ATR 70 by preheating gas stream 84 to a higher temperature. Thus more rapid startup of ATR 70 can be achieved. The system of FIG. 4 also differs from the system of FIG. 1 with respect to superheater 60. The superheating function carried out by heat transfer passage of the system of FIG. 2 is carried out by the heat transfer passage 97 of HRSG 90 in FIG. 4. Thus, in the system of FIG. 4, the heat transfer passage 97 of HRSG 90 is sized to include a superheating section which directly converts the humidified fuel stream 93 into superheated fuel stream 99. In the system of FIG. 4, pipe 98 is connected to heat transfer passage 97 and conveys superheated humidified fuel stream from heat transfer passage 97 to ATR inlet zone 68, where it is mixed with the other reactant components to form ATR reactant mixture 69 as previously described.

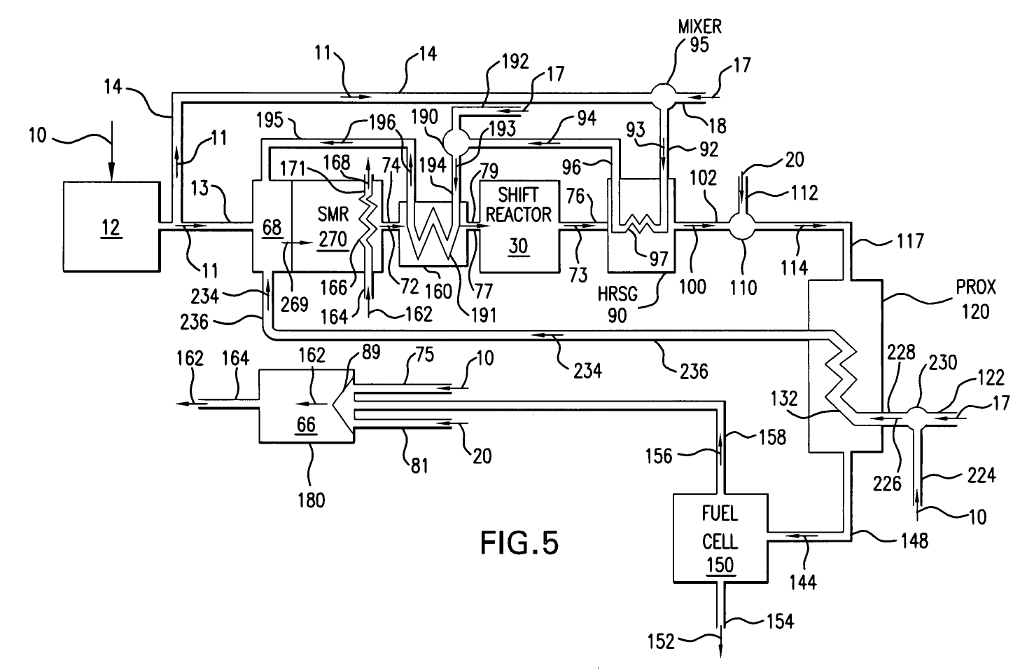

Yet another example of an improved hydrogen generation system is shown in FIG. 5 wherein the ATR 70 is replaced by a SMR reactor 270. Such a system can be used wherein simplification of the process is desired. Further, in this system, dilution of the reformed gas stream by nitrogen, when air is used as the oxygen containing gas stream, is avoided. Thus a reformed gas stream containing a higher concentration of hydrogen is produced for use in the fuel cell. Such a system eliminates the need for oxidant supply system 22 and humidification system 83. In this system, the coolant in the PROX reactor is a gas mixture 226 of fuel 10, supplied by pipe 224) and water stream 17, supplied by pipe 122, which is mixed in mixer 230. Gas mixture 226 is heated in heat transfer passage 132 of PROX reactor 120 to provide a heated gas mixture 234, which is conveyed by pipe 236 to reactor inlet zone 68. In reactor inlet zone 68, the heated gas mixture 234 is mixed with conditioned fuel 11 and humidified fuel 196 to produce a SMR reactant mixture 269. The SMR reactant mixture 269 which consists mostly of fuel and water is passed into the SMR catalyst in SMR reactor 270 to produce a hydrogen rich gas stream 72 which is conveyed to secondary HRSG 160 through pipe 74. The cooled hydrogen-rich gas stream 77 exiting secondary HRSG 160 is then passed to shift reactor 30 for further conversion of the excess steam and carbon-monoxide in the reformer gas to additional hydrogen and carbon-dioxide.

1. A process for generating hydrogen comprising:
a. mixing a stream of liquid water with a gaseous hydrocarbon fuel stream to produce a fuel-water mixture stream;
b. thereafter heating the fuel-water mixture stream by indirect heat exchange with a heat exchange fluid, to a temperature sufficient to evaporate the water into steam to produce a humidified fuel stream;
c. mixing the humidified fuel stream with an oxidant to produce a reformer reactant mixture comprising hydrocarbon fuel, oxidant, and steam;
d. reforming the reformer reactant mixture under ATR conditions to partially oxidize the hydrocarbon fuel in the reformer reactant mixture and allowing steam to reform the hydrocarbon fuel in the reformer reactant mixture to produce a hydrogen enriched reformer product gas, and
e. using the reformer product gas as the heat exchange fluid in step b to produce the humidified fuel stream.

2. The process of claim 1 wherein the fuel-water mixture is produced by spraying liquid water into the gaseous hydrocarbon fuel.

3. The process of claim 1 wherein the reformer product gas is subjected to water gas shift conditions to convert carbon monoxide and steam to carbon dioxide and hydrogen to produce a shift reactor product gas stream prior to step e.

4. The process of claim 3 wherein the humidified fuel stream of step b is further heated by indirect heat exchange with reformer product gas prior to the reformer product gas being subjected to water gas shift conditions.

5. The process of claim 1 wherein the hydrocarbon fuel is normally liquid and is heated to vaporize the hydrocarbon fuel prior to the mixing of step a.
